(19) United States
(12) Patent Application Publication
(10) Pub. No.: US 2012/0023144 A1
(43) Pub. Date: Jan. 26, 2012

(54) Managing Wear in Flash Memory

(75) Inventor: Bernardo Rub, Sudbury, MA (US)

(73) Assignee: SEAGATE TECHNOLOGY LLC, Scotts Valley, CA (US)

(21) Appl. No.: 12/840,920

(22) Filed: Jul. 21, 2010

(51) Int. Cl. G06F 17/30; G06F 12/02

(52) U.S. Cl. 707/813; 711/103; 711/E12.008; 707/E17.007

(57) ABSTRACT

At least two groupings are established for a plurality of erase units. The erase units include flash memory units that are available for writing subsequent to erasure. The groupings are based at least on a recent write frequency of data targeted for writing to the erase units. A wear criteria is determined for each of the erase units and the erase units are assigned to one of the respective groupings based on the wear criteria of the respective erase units and further based on a wear range assigned to each of the at least two groupings.

### SUMMARY

Various embodiments of the present invention are generally directed to a method and system for managing wear in a solid state non-volatile memory device. In one embodiment, a method, apparatus, system, and/or computer readable medium may facilitate establishing at least two groupings for a plurality of erase units. The erase units each include a plurality of flash memory units that are available for writing subsequent to erasure, and the groupings are based at least on a recent write frequency of data targeted for writing to the groupings. A wear criteria for each of the erase units is determined, and the erase units are assigned to one of the respective groupings based on the wear criteria of the respective erase units and further based on a wear range assigned to each of the at least two groupings.

In more particular arrangements, at least two groupings may include a hot grouping based on a higher recent write frequency of the data and a cold grouping based on a lower recent write frequency. In such an arrangement, the erase units may include a high wear group and a low wear group, each having erase units with high and low wear criteria, respectively, relative to each other. Further in such an arrangement, assigning the erase units may involve assigning the high wear group to the cold grouping and the low wear group to the hot grouping. In a more particular example of this arrangement, the erase units may include an intermediate wear group having wear criteria between that of the high wear group and the low wear group. In such a case, a medium grouping may be established based on a third recent write frequency between the respective write frequencies of the cold and hot groupings. The intermediate wear group may be assigned to the medium grouping.

In other more particular arrangements, each grouping may include a queue of the erase units, and the assigned erase units may be assigned within the respective queues based on the wear criteria. In one arrangement, the plurality of erase units may be available for writing subsequent to erasure via garbage collection. In such a case, the garbage collection may be applied to the erase units based on a garbage collection metric that can be adjusted based on an amount of wear associated with the memory units. In this example, the adjusted garbage collection metric changes when garbage collection is performed on the respective erase units. The garbage collection metric may include a stale page count and/or an elapsed since data was last written to the erase unit. In other more particular arrangements, the wear range assigned to each of the at least two groupings may be dynamically adjusted based on a collective wear of all erase units of a solid-state storage device.

In another embodiment of the invention, a method, apparatus, system, and/or computer readable medium may facilitate determining a distribution of a wear criterion associated with each of a plurality of erase units. Each erase unit includes a flash memory unit being considered for garbage collection based on a garbage collection metric associated with the erase unit. A subset of the erase units corresponding to an outlier of the distribution is determined, and the garbage collection metric of the subset is adjusted to facilitate changing when garbage collection is performed on the subset.

In more particular arrangements of this embodiment, a first part of the subset are more worn than those of the plurality of erase units not in the subset, and the garbage collection metric of the first part may therefore adjusted to reduce a time when garbage collection is performed on the first part. Also in such a case, a second part of the subset are less worn than those of the plurality of erase units not in the subset, and the garbage collection metric of the second part may be adjusted to increase a time when garbage collection is performed on the second part.

In more particular arrangements of this embodiment, the garbage collection metric may be adjusted differently for at least one erase units of the subset than for others of the subset based on the at least one erase unit being further outlying than the others of the subset. In these example embodiments, the garbage collection may include at least one of a stale page count and an elapsed time since data was last written to the erase unit.

These and other features and aspects of various embodiments of the present invention can be understood in view of the following detailed discussion and the accompanying drawings.

### BRIEF DESCRIPTION OF THE DRAWINGS

The discussion below makes reference to the following figures, wherein the same reference number may be used to identify the similar/same component in multiple figures.

FIG. 1 is a block diagram of a storage apparatus according to an example embodiment of the invention;

FIG. 2 is a block diagram of a garbage collection implementation according to an example embodiment of the invention;

FIGS. 3A-B are block diagrams illustrating a scheme for sorting erase units into queues according to an example embodiment of the invention;

FIGS. 4A-B are block diagrams illustrating an alternate scheme for sorting erase units into queues according to an example embodiment of the invention;

FIGS. 5A-B are block diagrams illustrating an alternate scheme for sorting erase units into a single queue according to an example embodiment of the invention;

FIGS. 6A-B are histograms of distributions of wear that may be used to adjust stale count metrics according to an example embodiment of the invention;

FIG. 7 is a flowchart illustrating a wear leveling procedure according to an example embodiment of the invention; and

FIG. 8 is a flowchart illustrating a wear leveling procedure according to another example embodiment of the invention.

### DETAILED DESCRIPTION

The present disclosure relates to managing flash memory units based on certain or various wear criteria. For example, the flash memory units may be used as the persistent storage media of a data storage device. In managing the flash memory units, groupings of erase units may be established taking into account the wear criteria, recent write history, and so forth, which can aid in functions such as garbage collection that are performed on an erase unit basis.

Flash memory is one example of non-volatile memory used with computers and other electronic devices. Non-volatile memory generally refers to a data storage device that retains data upon loss of power. Non-volatile data storage devices come in a variety of forms and serve a variety of purposes. These devices may be broken down into two general categories: solid state and non-solid state storage devices.

Non-solid state data storage devices include devices with moving parts, such as hard disk drives, optical drives and disks, floppy disks, and tape drives. These storage devices may move one or more media surfaces and/or an associated data head relative to one another in order to read a stream of bits. Solid-state storage devices differ from non-solid state devices in that they typically have no moving parts. Solid-state storage devices may be used for primary storage of data for a computing device, such as an embedded device, mobile device, personal computer, workstation computer, and server computer. Solid-state drives may also be put to other uses, such as removable storage (e.g., thumb drives) and for storing a basic input/output system (BIOS) that prepares a computer for booting an operating system.

Flash memory is one example of a solid-state storage media. Flash memory, e.g., NAND or NOR flash memory, generally includes cells similar to a metal-oxide semiconductor (MOS) field-effect transistor (FET), e.g., having a gate (control gate), a drain, and a source. In addition, the cell includes a “floating gate.” When a voltage is applied between the gate and the source, the voltage difference between the gate and the source creates an electric field, thereby allowing electrons to flow between the drain and the source in the conductive channel created by the electric field. When strong enough, the electric field may force electrons flowing in the channel onto the floating gate.

The number of electrons on the floating gate determines a threshold voltage level of the cell. When a selected voltage is applied to the floating gate, the differing values of current may flow through the gate depending on the value of the threshold voltage. This current flow can be used to characterize two or more states of the cell that represent data stored in the cell. This threshold voltage does not change upon removal of power to the cell, thereby facilitating persistent storage of the data in the cell. The threshold voltage of the floating gate can be changed by applying an elevated voltage to the control gate, thereby changing data stored in the cell. A relatively high reverse voltage can be applied to the control gate to return the cell to an initial, “erased” state.

Flash memory may be broken into two categories: single-level cell (SLC) and multi-level cell (MLC). In SLC flash memory, two voltage levels are used for each cell, thus allowing SLC flash memory to store one bit of information per cell. In MLC flash memory, more than two voltage levels are used for each cell, thus allowing MLC flash memory to store more than one bit per cell.

While flash memory is physically durable (e.g., highly resistant to effects of shock and vibration), the cells have a finite electrical life. That is, a cell may be written and erased a finite number of times before the structure of the cell may become physically compromised. Although MLC flash memory is capable of storing more bits than SLC flash memory, MLC flash memory typically suffers from more of this type of degradation/wear than does SLC flash memory.

In recognition that flash memory cells may degrade/wear, a controller may implement wear management, which may include a process known as wear leveling. Generally, wear leveling involves tracking write/erase cycles of particular cells, and distributing subsequent write/erase cycles between all available cells so as to evenly distribute the wear caused by the cycles. Other considerations of wear management may include reducing the number of write-erase cycles needed to achieve wear leveling over time (also referred to as reducing write amplification to the memory).

The controller may provide a flash translation layer (FTL) that creates a mapping between logical blocks seen by software (e.g., an operating system) and physical blocks, which correspond to the physical cells. By occasionally and/or continuously remapping logical blocks to physical blocks in response to writes/erasures, wear can be distributed among all of the cells while keeping the details of this activity hidden from the host.

Wear leveling is sometimes classified as static or dynamic. Dynamic wear leveling generally refers to the allocation of the least worn erasure unit as the next unit available for programming. Static wear leveling generally refers to copying valid data to a more worn location due to an inequity between wear of the source and target locations. The latter can be performed in response to an occasional scan of the unit that is triggered based on time criteria or other system events.

The need to distribute wear among cells is one feature that differentiates flash memory from non-solid state devices such as magnetic disk drives. Although disk drives may fail from mechanical wear, the magnetic media itself does not have a practical limit on the number of times it can be rewritten. Another distinguishing feature between hard drives and flash memory is how data is rewritten. In a magnetic media such as a disk drive, each unit of data (e.g., byte, word) may be arbitrarily overwritten by changing a magnetic polarity of a write head as it passes over the media. In contrast, flash memory cells must first be erased by applying a relatively high voltage to the cells before being written, or “programmed.”

For a number of reasons, these erasures are often performed on blocks of data (also referred to herein as “erase units”). Erase unit may include any blocks of data that are treated as a single unit. In many implementations, erase units are larger than the data storage units (e.g., pages) that may be individually read or programmed. In such a case, when data of an existing page needs to be changed, it may be inefficient to erase and rewrite the entire block in which the page resides, because other data within the block may not have changed. Instead, it may be more efficient to write the changes to empty pages in a new physical location, remap the logical to physical mapping via the FTL, and mark the old physical locations as invalid/stale.

After some time, numerous data storage units within a block may be marked as stale due to changes in data stored within the block. As a result, it may make sense to move any valid data out of the block to a new location, erase the block, and thereby make the block freshly available for programming. This process of tracking invalid/stale data units, moving of valid data units from an old block to a new block, and erasing the old block is sometimes collectively referred to as “garbage collection.” Garbage collection may be triggered by any number of events. For example, metrics (e.g., a count of stale units within a block) may be examined at regular intervals and garbage collection may be performed for any blocks for which the metrics exceed some threshold. Garbage collection may also be triggered in response to other events, such as read/writes, host requests, current inactivity state, device power up/down, explicit user request, device initialization/re-initialization, etc.

Garbage collection is often triggered by the number of stale units exceeding some threshold, although there are other reasons a block may be garbage collected. For example, a process referred to herein as “compaction” may target erase units that have relatively small amounts of invalid pages, and therefore would be unlikely candidates for garbage collection based on staleness counts. Nonetheless, by performing compaction, the formerly invalid pages of memory are freed for use, thereby improving overall storage efficiency. This process may be performed less frequently than other forms of garbage collection, e.g., using a slow sweep (e.g., time triggered examination of storage statistics/metrics of the storage device) or fast but infrequent sweep.

Erase units may also be targeted for garbage collection/erasure based on the last time data was written to the erase unit. For example, in a solid state memory device, even data that is unchanged for long amounts of time (cold data) may need to be refreshed at some minimum infrequent rate. The time between which updates may be required is referred to herein as “retention time.” A minimum update rate based on retention time may keep erase units cycling through garbage collection even if they are holding cold data.

As noted above, garbage collection may involve erasure of data blocks, and the number of erasures is also a criterion that may be considered when estimating wear of cells. For this reason, there may be some advantages in integrating the functions of garbage collection with those of wear leveling. Such integration may facilitate implementing both wear leveling and garbage collection as a continuous process. This may be a more streamlined approach than implementing these processes separately, and may provide an optimal balance between extending life of the storage device and reducing the overhead needed to implement garbage collection.

One issue often considered in solid state memory devices is deciding where to put each piece of data as it comes in. As will be described in greater detail below, the devices may use a concept known as “temperature” of the data when segregating data for writing. Segregation by temperature may involve grouping incoming data with other data of the same or similar temperature. In such a device, there may be some number of erase units in the process of being filled with data, one for each of the temperature groupings. Once the temperature grouping for incoming data is determined, then that data is targeted for a particular area of writing, and that targeted area may correspond to a particular erase unit.

Part of the garbage collection process involves preparing erase units to receive data. When an erase unit currently being filled for one of the temperature groupings is filled, then an empty erase unit needs to be allocated to receive data belonging to that temperature grouping. In such a case a determination is made, namely which should be the next erase unit to receive data at that temperature. This is in contrast to more conventional framing of the issue in regards to wear leveling, which may generally involve deciding where the just-received data should be placed. In the embodiments described here, there may be no need to keep checking for the least worn unit every time a new unit of data comes in. Wear is considered when an erase unit is allocated to a temperature grouping, and this can preclude the need to check wear at the time data is written.

It should further be noted that the above mentioned conventional practice of picking the least worn unit as the next unit available for programming may not always be the best choice. For example, if an erase unit currently being used for “cold” data (e.g., data that has not seen recent activity/change) is filled up and some cold data remains to be written, this cold data will need to go into a newly erased erase unit. In this case, using the least worn unit as the next available unit for programming may be the wrong decision. This is because the data that needs to be written next is cold data. Cold data, by definition, is unlikely to change, and so there is a decreased likelihood that the selected low-wear erase unit will see further activity and incur further wear. This may be contrary to the reasons for which the erase unit was chosen for programming in the first place.

A wear leveling system according to the disclosed embodiments may also consider a maximum time elapsed since data was last written as a part of the wear leveling approach. In a practical system, the cost for this approach may be nominal, because, as described above, data degrades with time and so may be refreshed based on retention time anyway. It may be appropriate, in such a case, to further consider retention time as a criterion when sending an erase unit to garbage collection.

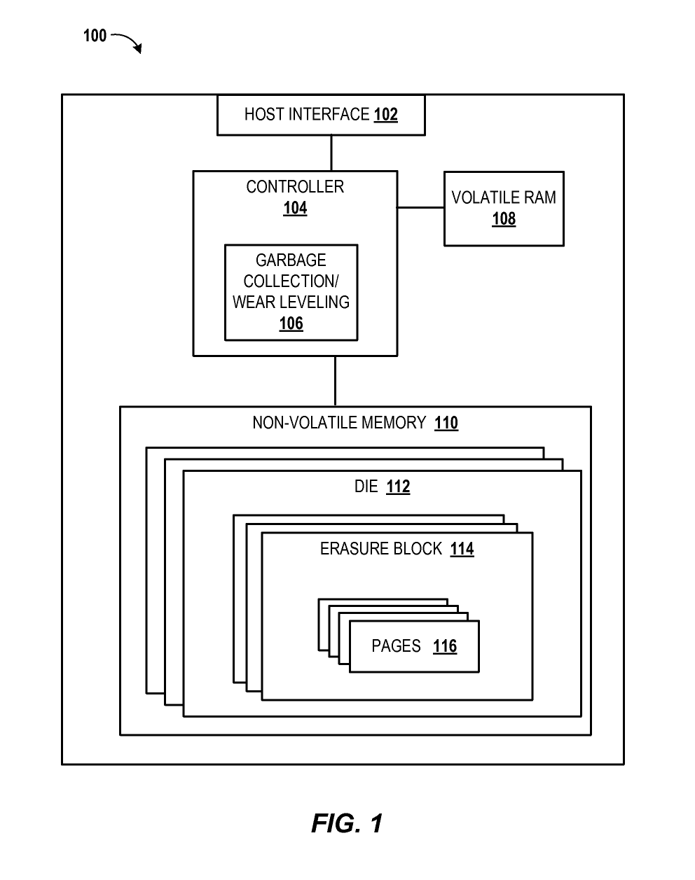

In reference now to FIG. 1, a block diagram illustrates an apparatus 100 which may incorporate concepts of the present invention. The apparatus 100 may include any manner of persistent storage device, including a solid-state drive (SSD), thumb drive, memory card, embedded device storage, etc. A host interface 102 may facilitate communications between the apparatus 100 and other devices, e.g., a computer. For example, the apparatus 100 may be configured as an SSD, in which case the interface 102 may be compatible with standard hard drive data interfaces, such as Serial Advanced Technology Attachment (SATA), Small Computer System Interface (SCSI), Integrated Device Electronics (IDE), etc.

The apparatus 100 includes one or more controllers 104, which may include general- or special-purpose processors that perform operations of the apparatus. The controller 104 may include any combination of microprocessors, digital signal processor (DSPs), application specific integrated circuits (ASICs), field programmable gate arrays (FPGAs), or other equivalent integrated or discrete logic circuitry suitable for performing the various functions described herein. Among the functions provided by the controller 104 are that of garbage collection and wear leveling, which is represented here by functional module 106. The module 106 may be implemented using any combination of hardware, software, and firmware. The controller 104 may use volatile random-access memory (RAM) 108 during operations. The RAM 108 may be used, among other things, to cache data read from or written to non-volatile memory 110, map logical to physical addresses, and store other operational data used by the controller 104 and other components of the apparatus 100.

The non-volatile memory 110 includes the circuitry used to persistently store both user data and other data managed internally by apparatus 100. The non-volatile memory 110 may include one or more flash dies 112, which individually contain a portion of the total storage capacity of the apparatus 100. The dies 112 may be stacked to lower costs. For example, two 8-gigabit dies may be stacked to form a 16-gigabit die at a lower cost than using a single, monolithic 16-gigabit die. In such a case, the resulting 16-gigabit die, whether stacked or monolithic, may be used alone to form a 2-gigabyte (GB) drive, or assembled with multiple others in the memory 110 to form higher capacity drives.

The memory contained within individual dies 112 may be further partitioned into blocks, here annotated as erasure blocks/units 114. The erasure blocks 114 represent the smallest individually erasable portions of memory 110. The erasure blocks 114 in turn include a number of pages 116 that represent the smallest portion of data that can be individually programmed or read. In a NAND configuration, for example, the page sizes may range from 512 bytes to 4 kilobytes (KB), and the erasure block sizes may range from 16 KB to 512 KB. It will be appreciated that the present invention is independent of any particular size of the pages 116 and blocks 114, and the concepts described herein may be equally applicable to smaller or larger data unit sizes.

It should be appreciated that an end user of the apparatus 100 (e.g., host computer) may deal with data structures that are smaller than the size of individual pages 116. Accordingly, the controller 104 may buffer data in the volatile RAM 108 until enough data is available to program one or more pages 116. The controller 104 may also maintain mappings of logical block address (LBAs) to physical addresses in the volatile RAM 108, as these mappings may, in some cases, may be subject to frequent changes based on a current level of write activity.

Data stored in the non-volatile memory 110 may be often grouped together for mapping efficiency reasons and/or flash architecture reasons. If the host changes any of the data in the SSD, the entire group of data may need to be moved and mapped to another region of the storage media. In the case of an SSD utilizing NAND flash, this grouping may affect all data within an erasure block, whether the fundamental mapping unit is an erasure block, or a programming page within an erasure block. All data within an erasure block can be affected because, when an erasure block is needed to hold new writes, any data in the erasure block that is still “valid” (e.g., data that has not been superseded by further data from the host) is copied to a newly-mapped unit so that the entire erasure block can be made “invalid” and eligible for erasure and reuse. If all the valid data in an erasure block that is being copied share one or more characteristics, there may be significant performance and/or wear gains from keeping this data segregated from data with dissimilar characteristics.

For example, data may be grouped based on the data's “temperature.” The temperature of data generally refers to the frequency of recent access to the data. In one embodiment of the invention, data that has a higher frequency of recent write access may be said to have a higher temperature (or be “hotter”) than data that has a lower frequency of write access. Data may categorized, for example, as “hot” and “cold”, “hot,” “warm,” and “cold,” or the like, based on predetermined or configurable threshold levels. Or, rather than categorizing data as “hot,” “warm,” and “cold,” other designators such as a numerical scale may be used (e.g., 1-10).

The term “temperature grouping” may also used to describe grouping data blocks/addresses based on other factors besides frequency of re-writes to the affected block/address. One such factor is spatial repetition. For example, certain types of data structures may be sequentially rewritten to a number of addresses in the same order. Thus if one of the addresses is assigned a temperature grouping based on current levels of activity, then all of the addresses of the sequentially written group may also be assigned to that temperature grouping. In other implementations, the consideration of sequential grouping may be handled separately from temperature groupings. For example, a parallel or subsequent process related to garbage collection and/or wear leveling may deal with sequential groupings outside the considerations of temperature discussed herein.

When data needs to be written to storage media in response to garbage collection, host writes, or any other operation, the temperature of the data may be determined, e.g., via controller 104. Data with similar temperatures may be grouped together for purposes such as garbage collection and write availability. Depending on the workloads and observed or characterized phenomena, the system may designate any number ‘N’ temperature groups (e.g., if N=2, then data may be characterized as hot or cold and if N=3, then data may be characterized as hot, warm, or cold, and so forth). Within each grouping of temperature, the system may order the data so that as data becomes hotter or colder, the system is able to determine which logical data space will be added or dropped from a group. For a more detailed description of how temperature may be considered when managing data in flash memory, reference is made to commonly owned patent application, U.S. Ser. No. 12/765,761 entitled “DATA SEGREGATION IN A STORAGE DEVICE,” which is incorporated by reference in its entirety and referred to hereinafter as the “DATA SEGREGATION” reference.

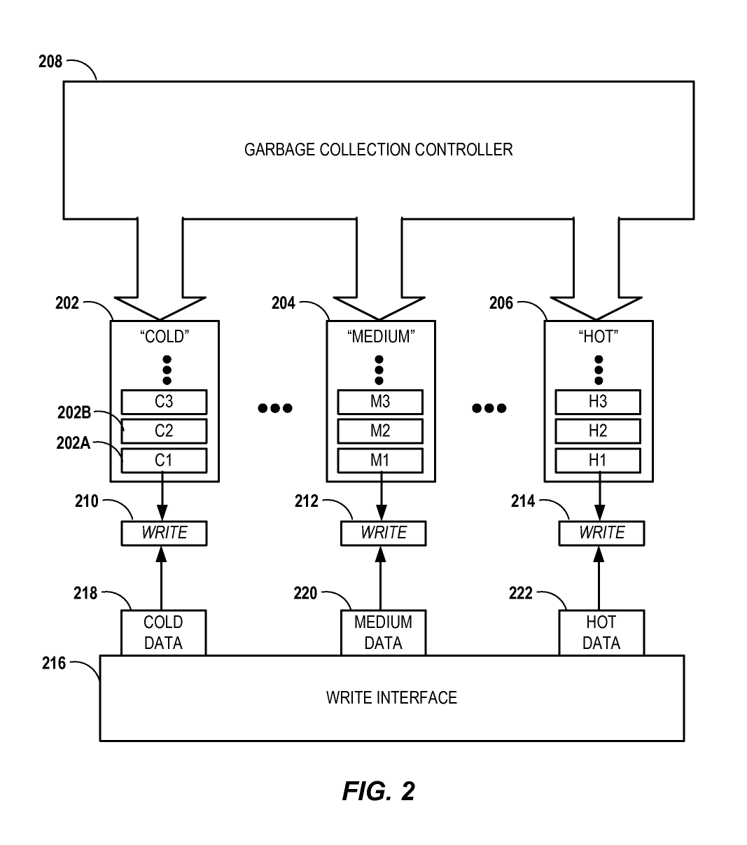

In reference now to FIG. 2, a block diagram illustrates an arrangement for ordering data based on temperature according to an example embodiment of the invention. Generally, a number of queues 202, 204, 206 are formed from one or more erase units (e.g., erase units 202A, 202B). The erase units 202A, 202B are generally collections of memory cells that may be targeted for collective erasure before, during, or after being assigned to a queue 202, 204, 206. A garbage collection controller 208 is represented as a functional module that handles various tasks related to maintenance of the queues. For example, the garbage collection controller 208 may determine whether existing erase units are ready for garbage collection, manage data transfers and erasures, provide the erase units for reuse, etc.

A garbage collection controller 208 (or similar functional unit) according to an embodiment of the present invention is implemented such that wear leveling is an integral part of garbage collection. In order to do this, the garbage collection controller 208 may utilize using wear criteria, among other things, to arrange the queues. In other arrangements, garbage collection policies (e.g., determining when an erase unit is ready for garbage collection) may also be altered based on wear criteria. In both these arrangements, wear leveling may be integrated with garbage collection as a continuous process that takes into account both distribution of wear and efficient use of storage resources when selecting memory units for writing.

Often, wear of flash memory cells is considered to be a function of the number of erase cycles. However, this need not be the only criterion that is considered, and the various embodiments of the invention described herein are independent of how wear is defined and/or measured. For example, different blocks within a die or blocks in different dies may degrade at different rates as a function of erase cycles. This could be due, for example, to process variations from die to die or variability within a die. Therefore it may be more useful to derive wear from error rate or some manner of margined error rates derived by varying the detector thresholds or a histogram of the cell voltages. Thus, if there are physical differences between blocks and the workload is uniformly distributed (e.g., no temperature differences) then approaches for wear leveling that focus solely on erase counts of blocks may not work as expected. A more robust wear leveling may be obtained by looking at a number of different criteria, and applying wear leveling as changes in garbage collection criteria (e.g., applying an offset to the stale count or other shifts that cause some blocks to be sent to garbage collection earlier or later than would otherwise be optimal).

Generally, any combination of parametric measurements that correlate to cell degradation may be used instead of or in combination with numbers of erase cycles to track or estimate wear. Embodiments of the invention may utilize any generally accepted function or parameter determinable by the garbage collection controller 208 or equivalents thereof. The garbage collection controller 208 may already utilize its own criteria that are particular to the garbage collection process. For example, one goal of garbage collection may be to minimize write amplification. Write amplification generally refers to additional data written to the media device needed to write a particular amount of data from the host. For example, a host may request to write one megabyte of data to a flash media device. In order to fulfill this request, the media device may need to write an additional 100 kilobytes of data through internal garbage collection in order to free storage space needed to fulfill the request. In such a case, the write amplification may be said to be 1.1, e.g., requiring an extra 10% of data to be written.

As is described in greater detail in the “DATA SEGREGATION” reference, one way of optimizing garbage collection is to recognize different temperatures of data being written. Data that is undergoing more frequent rewriting, e.g., due to frequent changes in the data, is labeled as “hot.” Data that has gone some period of time without any changes being written may be labeled as “cold.” As these names suggest, the temperature of data may encompass a spectrum of activity levels, and such levels may be arbitrarily placed into various categories such as hot, warm, cold, etc.

There may be a number of factors considered when categorizing data temperature in this way, and there may be any number of temperature categories. For example, the illustrated erase unit queues 202, 204, and 206 are each assigned a different temperature category: cold, medium, and hot. The use of three categories in this example is for purposes of illustration and not of limitation. The present invention may be used in any arrangement that categorizes data activity in this way, and may be applicable to implementations using fewer or greater temperature groupings. Further, the categories may be identified using any symbols of conventional significance, such as labels, numbers, symbols, etc. Further, the temperature groupings may also take into account other aspects of the data, such as spatial groupings, specially designated data types (e.g., non-volatile cache files), etc.

Erase units are grouped into temperature categories by the garbage collection controller 208, as indicated by respective cold, medium and hot queues 202, 204, 206. By grouping data with similar temperatures, it is more likely that the data will be rewritten at a similar frequency. As described in the “DATA SEGREGATION” reference, data within particular erase units of queues 202, 204, and 206 may become “stale” at similar frequencies, thus minimizing the amount of data needing to be copied out of one erase unit into another erase unit to facilitate garbage collection on the first erase unit. As a result, the write amplification caused by garbage collection may significantly decrease.

When data needs to be written/programmed, particular erase unit may selected be based on temperature. This is illustrated in FIG. 2 by currently selected erase units 210, 212, 214 that are being selected from the respective queues 202, 204, and 206 to have data written to pages within each unit. A write interface 216 may segregate currently written data based on temperature categories, here shown as cold 218, medium 220, and hot 222 data. For example, data being written directly from a host interface 102 may be generally categorized as hot data 222. A higher temperature may also be assigned to all physical addresses associated with a data structure (e.g., file, stream) if the data structure has currently experienced significant write/rewrite activity.

The medium and cold data 220, 218 may originate from the garbage collection controller 208 and/or other internal functional components of a storage device. For example, garbage collection controller 208 may re-categorize data from hot to medium or medium to cold when the data has not seen recent write/rewrite activity and is moved to a new page/block as part of the garbage collection process. Such re-categorization may be based on metrics regarding a particular page, such as time data was written to the page, activity level of linked/related pages, etc.

In one embodiment of the invention, erase units may be assigned to a particular one the queues 202, 204, 206 based on a wear metric associated with the erase units. Generally, the intention is to assign erase units with the most wear to a queue where it is least likely that the erase unit will be currently reused. Further, the erase unit may be assigned to a location within each queue that reflects this desire to use the least worn erase units first and the more worn erase units later. As previously noted, this aspect of the invention is independent of how wear is defined or measured within the apparatus. In some embodiments, a single numeric parameter may be used to represent wear, thereby simplifying comparisons between erase units to properly place them in the queues 202, 204, 206.

The consideration of wear when assigning erase units to the queues 202, 204, 206 need not affect the garbage collection policy. The garbage collection criteria may still be chosen to optimize write amplification for each temperature grouping. In some arrangements, each temperature grouping may have more memory available for storage than is advertised as being available to the host/user. Providing extra, “over-provisioned,” memory may allow a solid-state storage device to operate faster, and further extend the life of the device. The garbage collection policy may also take into account over-provisioning, and different temperature groupings may have different amounts of over-provisioning.

In one example embodiment, a functional unit of the solid state storage device (e.g., garbage collection controller 208) may perform garbage collection to empty a set of erase units, and sort the empty erase units by wear. The empty erase units are then distributed among the temperature groupings (e.g., represented by queues 202, 204, and 206). In one embodiment, the units with the most wear are assigned to the coldest grouping, and the units with the least wear are assigned to the warmest grouping. Within each group, the units with the least wear may be placed at or near the head of the queue, and units with the most wear may be placed at or near the end of the queue.

Although FIG. 2 shows the erase units arranged into queues, the present invention need not be limited to using queues to establish temperature groupings of erase units. For example, it may be possible to pool all of the available erase units into a single group using any data collection paradigm known in the art. In such a case, erase units may be picked from that pool based on sorting part of or all of the members the pool. In such a case, the allocation of erase units to a temperature grouping can still be made be an inverse relationship to the wear of those units, e.g., the most worn to the coldest grouping and vice versa. While the erase units in such an implementation may be formed into a single group, the erase units may be selected from particular portions within the group based on the sorting.

In some cases, the controller 208 may also need to consider how to manage the number of erase units allocated to each temperature grouping. For example, the hot grouping may require erase units at a faster rate, and as such may require more available units. Further, the rate and amount of hot data may be driven by activity from the host, and as a result may be less predictable than colder data, which may be managed internally by the storage device. Enforcing a fixed allocation of erase units is one way to manage the overprovisioning for that temperature grouping. The controller 208 may also be configured to dynamically reallocate erase units based on current or predicted use conditions.

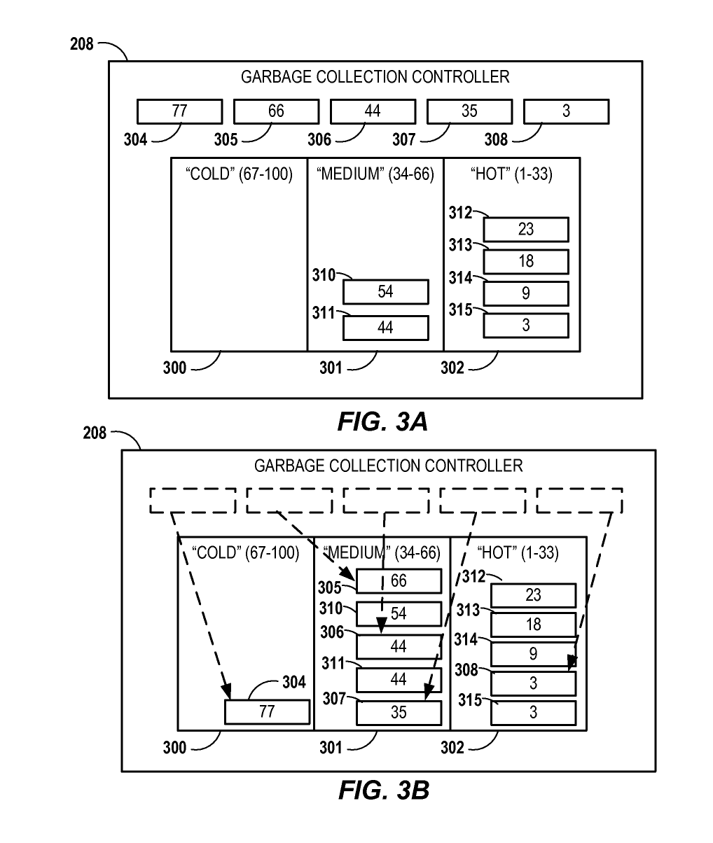

There are a number of ways in which the assignment of erase units to and within a particular queue may be implemented. In reference now to FIGS. 3A and 3B, an example with fixed partitioning is examined. In these examples, a garbage collection controller 208 utilizes three queues 300-302 that are partitioned by temperature, and further partitioned by the value of wear metrics associated with erase units 304-315 that are placed into the queues. In this and the examples that follow, wear of an erase unit is denoted by an integer between 1 and 100, with 1 denoting the least wear and 100 denoting the most wear. It is assumed that this is a linear scale, although the concepts may be equally valid using other scales (e.g., logarithmic).

It should be noted that the numeric scale and distribution of wear shown in these examples is not intended to demonstrate a realistic example of wear tracking, but only to demonstrate how erase units may be assigned to and within queues. For example, in FIG. 3A, the lowest wear value shown for the erase units is 3 (erase units 308 and 315) and the highest value is 77 (erase unit 304). However, if the wear leveling was being implemented as a continuous process, then the wear values would be expected to be much closer to each other, e.g., much lower standard deviation than shown.

In FIG. 3A, the queues 300-302 are each assigned a fixed range of wear values. In particular, the cold queue 300 receives the erase units with the highest wear, with a range from 67-100. The medium and hot queues 301, 302 receive erase units of increasingly less wear, with respective ranges of 34-66 and 1-33. Erase units 310-315 have already been placed in the queues 301, 302 from a previous operation. The queues 300-302 may contain additional erase units that are not shown; erase units 310-315 are included to show how subsequent additions to the queues may interact with existing elements of the queues.

Erase units 304-308 seen in FIG. 3A may have already been erased and sorted by wear metrics, but have yet to be assigned to a temperature grouping by the garbage collection controller 208. In this case, the assignment of the erase units 304-308 to a queue only requires looking at the wear metrics of each erase unit 304-308 and determining into which of the ranges defined for queues 300-302 each erase unit falls. The result of this is shown in FIG. 3B. Also note that the erase units 304-308 are sorted within each queue 300-302 so that the erase unit with the least wear is placed near the front of the queue (corresponding to the bottom in this illustration) for next removal. For example, erase unit 307 has the lowest wear metric for queue 301, and so is placed at the front of the queue.

As may be apparent from FIG. 3B, the use of fixed wear ranges for the queues 300-302 may lead to a skewed distribution of new wear units within the queues 300-302. This is not unexpected, because when a device is new, most (if not all) erase units will have low wear, and therefore there might be no units being assigned to the cold queue 300 for some time. This could be alleviated if the next coldest queue (e.g., medium queue 301) is accessed if the cold queue 300 is currently empty. Alternatively, each queue 300-302 may be partitioned, not based on the full scale used to calculate wear, but based on a current global extremum of the erase unit wear metrics. This may involve occasionally or continually adjusting the partitioning assigned to the queues 300-302 over time.

Another consideration of this and other implementations is whether and how to balance sizes of the queues. As discussed above, some scenarios may lead to some queues becoming much larger than others. In some instances, it may be desirable to maintain roughly equal queue sizes. In other situations (e.g., based on current use patterns) it may be beneficial to adjust the queues to unequal sizes. The queues may be adjusted in this way as a continuous process, e.g., as erase units are added and/or removed from queues. The queues may additionally or alternately be adjusted on periodic scans.

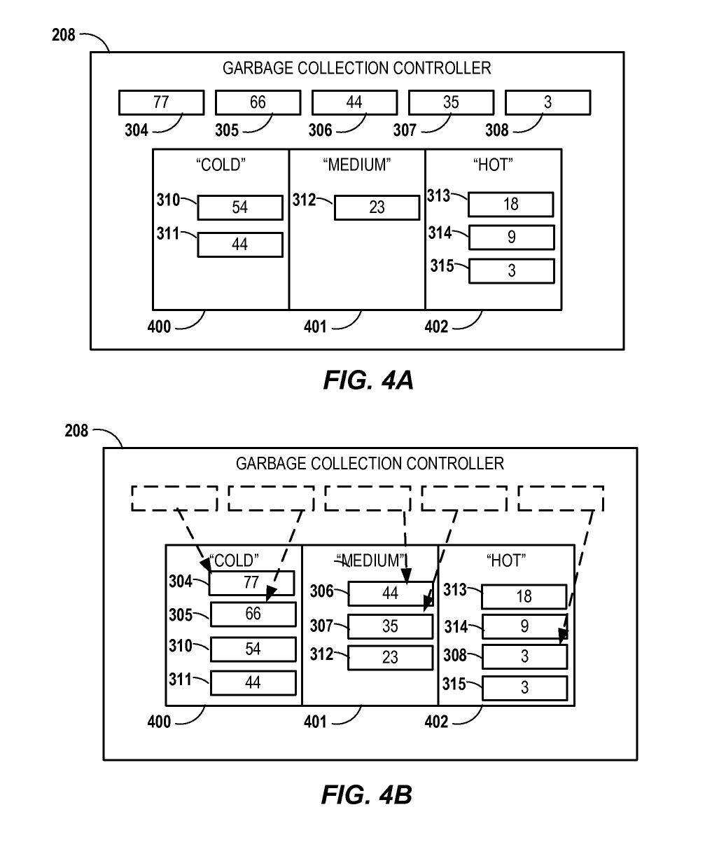

Another approach in assigning wear units to queues is shown in FIGS. 4A-B, which uses a similar garbage collection controller 208 and erase units 304-315 as seen in FIGS. 3A-B. In this case, the garbage collection controller 208 uses queues 400-402 that are not assigned any fixed range of wear metric. Instead, each group of erase units is sorted to the queues 400-402 based on the distribution of the group at the time they are placed in the queues 400-402. In this example, a group of erase units is evenly divided into three groups (or however many temperature groupings are ultimately used) based on the lowest and highest wear values within the group.

For example, in the previously sorted group of erase units 310-315, the lowest value is 3 and highest is 54, thus giving a total range of 51, which can be evenly divided by three into three ranges of 17. Accordingly, erase units having wear values from 3-19 may be assigned to the hot queue 402, those with values between 20-36 may be assigned to the medium queue 401, and those with values between 37-54 may be assigned to the cold queue 400. A similar procedure is performed for newly sorted erase units 304-308, but with wear metric ranges of 2-27, 28-52, and 53-77 for the respective hot, medium and cold groupings due to the different wear range of this group. The resulting assignment and inter-queue sorting is shown in FIG. 4B. Other ways of partitioning groups may be devised, such as using a histogram of the wear values instead of even linear division based on the range of the group.

One advantage to this approach is that it may tend to even out the size of the queues 400-402 regardless of the average wear state of all erase units. However, such an approach may need some modification to deal with certain cases. For one, if a particular group is skewed to low or high amounts of wear, some units may be sub-optimally assigned. In another case, one erase unit may be assigned (or more generally, a value of erase units less than the N-temperature groupings being used) making it unclear into which group it should be place. In such a case, some other criteria may be used to determine in which queue the erase unit should be placed. Such assignment could be based on global wear distribution metrics as described in relation to FIGS. 3A-B, and/or based on average values of units already in the queues. A similar situation may arise if there more than N erase units are to be placed into the queues, but all have identical wear values.

Another artifact of this approach is seen in FIG. 4B, where erase units 306 and 311 are placed in different queues 401 and 400, respectively, even though the wear values are the same. This may be an acceptable result, as the sorting within the queues 400, 401 will still enforce some or all of the desired behavior (e.g., erase unit 311 is at the front of queue 400, while erase unit 306 is at the end of queue 401). The chances of this occurrence and/or its effects might also be mitigated by the expectation that the wear values would be more closely grouped than illustrated because wear leveling is a continuous process integrated with garbage collection. This might be dealt with in implementations where the relative sizes of the queues may be occasionally adjusted. In such a case, this adjustment might also involve resorting erase units within and between the queues based on the wear values of the currently queued erase units.

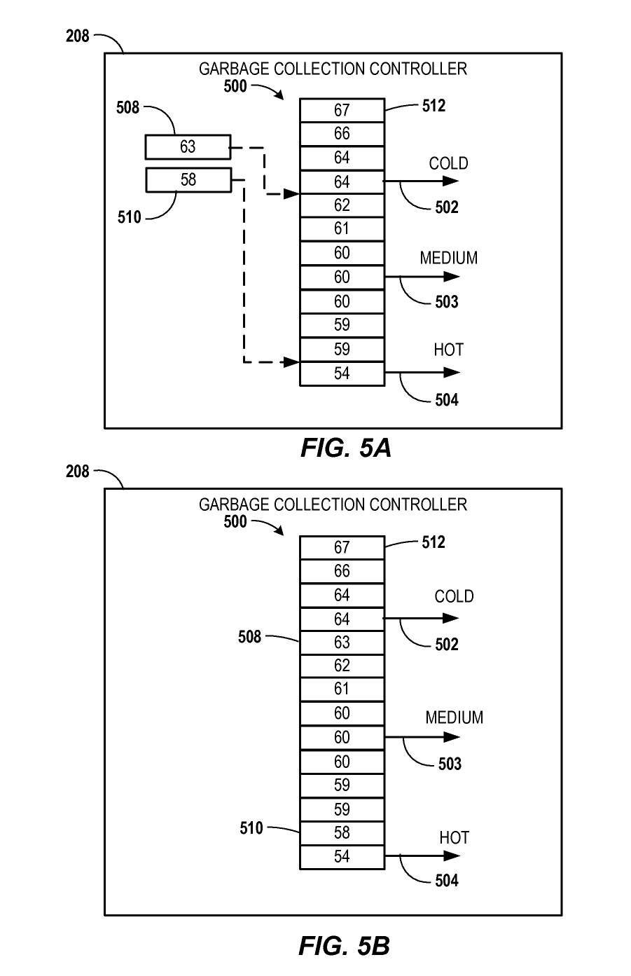

Yet another implementation of temperature-grouped garbage collection queues according to an embodiment of the invention is shown in FIGS. 5A-B. A garbage collection controller 208 similar to that discussed above may utilize a single queue 500 for managing all erase units available for re-use. This queue 500 may be automatically sorted based on new units being added, such as erase units 508 and 510. This queue 500 differs from a traditional queue in that, instead of a single point (e.g., the front) where an erase unit is extracted, there are numerous locations from which erase units may be extracted. In this example, there are three extraction points 502-504 corresponding to three different temperature groupings as previously discussed. Generally the points 502-504 may at least include a reference to the next erase unit to be extracted for a particular temperature grouping.

This type of queue 500 may be implemented using a data structure such as a linked list. In such a case, when the new erase units 508 are added, the controller 208 may traverse the queue 500 starting at one end (e.g., at element 512) and insert the elements 508, 510 in a location appropriate based on the sorting implemented within the queue 500. The result of such an insertion is seen in FIG. 5B. Note that the insertion may also cause a relocation of the extraction points 502-504. For example, if a relatively large number of erase units were inserted between extraction points 503 and 504, the extraction points 503 and 502 may need to be moved “downwards” to even out the relative size of the three queues. Similarly, if a relatively large number of erase units are extracted from one of the points 502-504 but not the others, then one or more of the points 502, 503 may be shifted to even out the number of erase units allocated to each temperature group. There may be no reason in such a case to move the extraction point 504, because it is at the “true” front of the queue 500. There may be other reasons to move 504, e.g., to temporarily ensure one or more erase units are not de-queued.

It will be appreciated that the implementations shown in FIG. 4A-B, 5A-B, and 6A-B are merely examples provided for purposes of understanding the invention, and not intended to limit the scope of the invention. Many variations of these implementations may be possible. Further, combinations of features of the different implementations may be possible. For example, the garbage collection controller 208 may initial use a relatively fixed partition of queues such as 300-302, but adjust the partitioning based on recent activity such as shown for queues 400-402. Similarly, both of these types of queues 300-302, 400-402 may be subject to occasionally resorting and redistributing of erase units among the individual queues such as shown for queue 500.

Under some conditions, erase units may still not experience sufficient wear leveling. For example, if the data storage device sees significant sustained activity under a single temperature category, then erase units from those queues may be disproportionately selected for writing compared to erase units from other temperature groups. As a result, embodiments of the present invention may include other features for adjusting the criteria used to select erase units for garbage collection that is influenced by wear.

As previously discussed, an erase unit may include a number of pages, each page possibly being empty (e.g., available for being programmed), filled with valid data, or filled with invalid (e.g., stale) data. The garbage collection processor may maintain and examine these (and other) characteristics of the pages to form a metric associated with an erase unit. This metric can be used to determine when to perform garbage collection on the erase unit. For example, if an erase unit has 16 pages and 12 of them are stale, this has reached a threshold of 75% staleness that could trigger garbage collection. This staleness value may also be combined with other parameters to form a composite garbage collection metric.

In some cases, erase units may not benefit from sorting into temperature grouped queues. In such a case, the garbage collection metrics can be used to nudge the rate of wear in the desired direction. For example, a parameter called Adjusted Stale Count may be used instead of the number of stale pages (or amount of stale data) in calculating a garbage collection metric. As the name implies, the Adjusted Stale Count may be obtained by adjusting (e.g., adding or subtracting a number to) the number of stale pages of an erase unit. The amount and direction of the adjustment may be a function of the deviation of the particular erase unit's wear from the mean or median of the population.

One rationale for applying an Adjusted Stale Count is that the rate of wear of an erase unit may be considered a function of how frequently it is erased. Sorting may achieve that objective by placing the least worn erase units in a group that is erased more frequently and placing the most worn units in a group that is erased less frequently. However, if the sorting is not sufficient to achieve this goal, adjusting garbage collection criteria may be used to directly impact the erase frequency. For example, more worn erase units would have a lower Adjusted Stale Count so that it takes longer before being chosen for garbage collection, thereby reducing further wear. Similarly, less worn erase units having higher Adjusted Stale Count would be chosen earlier and/or more often for garbage collection, thus increasing subsequent wear on these erase units.

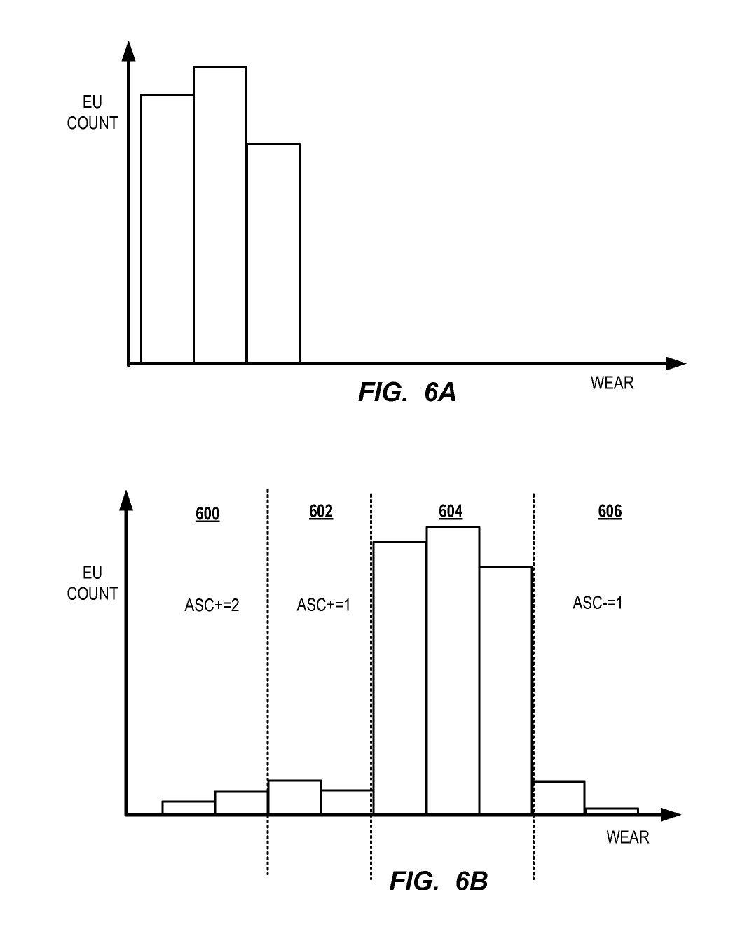

In reference now to FIGS. 6A-B, histograms illustrate examples of how an adjusted garbage collection metric may be applied according to embodiments of the invention. This adjusted metric may include any combination of metrics, including an adjusted stale count and an adjusted time since the block was last written. The histogram in FIG. 6A shows an example of how wear may be distributed at a relatively early stage of a device's life. This may represent a reasonably tight distribution formed using temperature sorting by wear, for example. However, in later stages of a device's life (and/or possibly based on the wear leveling techniques used), the distribution of wear over erase blocks may appear more similar to that seen in FIG. 6B. The majority of erase units may form a fairly desirable distribution such as in region 604. However some erase units also exhibit outlier values of wear, as seen in regions 600, 602, and 606.

There may be a number of different criteria that may be used to define how outliers such as areas 600, 602, 606 are defined. For example, if the distribution is treated as Gaussian, the outliers may be defined as values lying outside a predefined number of standard deviations from the mean of the population. In a true Gaussian distribution, 95% of the data lies within two standard deviations of the mean, and 99.7% lie within three standard deviations of the mean. Other statistical distributions and criteria may be used as known in the art.

In these outlier areas 600, 602, 606, it may be useful to adjust the garbage collection metric of the associated erase units. In regions 600 and 602, the wear is unusually low, and so the garbage collection metric is increased to hasten the time when garbage collection occurs. Further, region 600 is further from the average/median, and so garbage collection metric is increased for erase units in this region by a greater amount than for those erase units in region 602. Similarly, in region 606, wear is abnormally high, and so the adjusted s garbage collection metric is decreased to delay when garbage collection occurs.

It will be appreciated that actual increment or decrement values may be highly dependent on the garbage collection scheme used, and so no limitation is intended by the choice of values shown in FIG. 6B, other than to indicate that there may be some differences in value of relative change of the adjusted garbage collection metric. The amount of adjustment may be any step and/or continuous function of the deviation of a particular unit's wear compared to the rest of the population. There could be a dead band or other tolerance so that there is no adjustment for small wear deviations.

It should noted that this approach may disturb the optimality of the garbage collection algorithm, e.g., negatively impacting write amplification. For this reason, it may be appropriate to use it only on a segment of the erase unit population that is not being helped sufficiently by sorting, such as high wear erase units in a cold grouping and low wear erase units in a hot grouping. The system designer may also need to take into account that adjusted stale counts may deviate from the actual stale pages in an erase unit. For example, care might be needed to check whether a stale count of erase units in region 606 have be decremented to such a level that it would not available for garbage collection even if all of its pages were stale. Such a result may be acceptable in some conditions, e.g., where there is ample free storage, as this would be rectified as the wear of other erase units catches up to the adjusted units. However, at some point it may be important to provide the advertised storage capacity by garbage collecting highly worn blocks, even if this results in sub-optimal wear leveling.

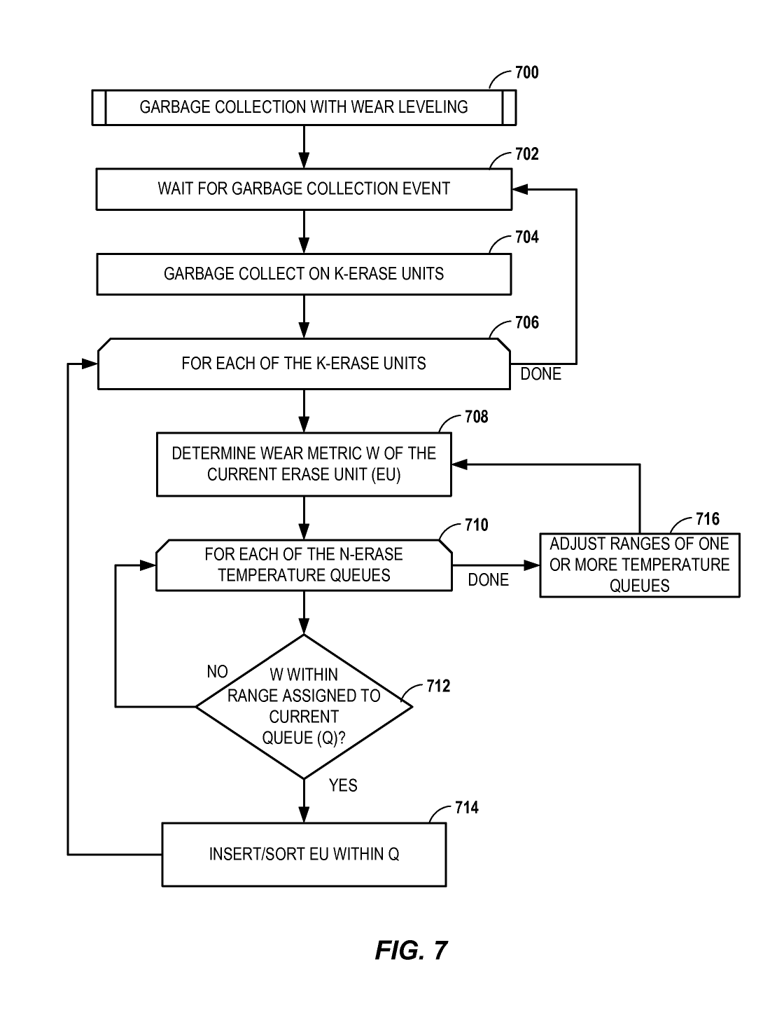

In reference now to FIG. 7, a flowchart illustrates procedure 700 according to an example embodiment of the invention. This procedure 700 may be implemented in any apparatus described herein and equivalents thereof, and may also be implemented as a computer-readable storage medium storing processor-executable instructions. The procedure 700 may include a wait state 702 where some external event triggers garbage collection. In response, a number of erase units may be selected and garbage collection performed 704. Each of the erase units may then be iterated through, as indicated by loop limit block 706. For each erase unit (EU), a wear metric W is determined 708. Each of N-temperature erase queues (Q) may also be iterated through, as indicated by loop limit block 710.

If the wear metric W is within the range associated with the current Q, as tested in block 712, then EU is inserted/sorted 714 into Q. In such a case, the inner loop 710 is broken out of and the next EU is selected 706. If the test 712 determines that the wear metric W is not within the range associated with Q, the next Q is selected at 710, and this loop repeats. In some implementations, the test 712 may be configured so as to guarantee to return true for at least one combination of Q and EU, or choose a suitable default queue. However, if loop 710 quits without success of block 712, then adjustment 716 of the range associated with the queues may be desirable or required. This may occur in cases such as where a global range is used to assign wear ratings to the queues, and recent garbage collection pushes an EU outside this limit. It will be appreciated that this type of adjustment 716 may be performed outside the procedure 700, e.g., by a parallel executing process. In other cases, the outlying EU may be inserted in the hottest or coldest queue as appropriate, although the queue ranges may still need to be adjusted 716 thereafter.

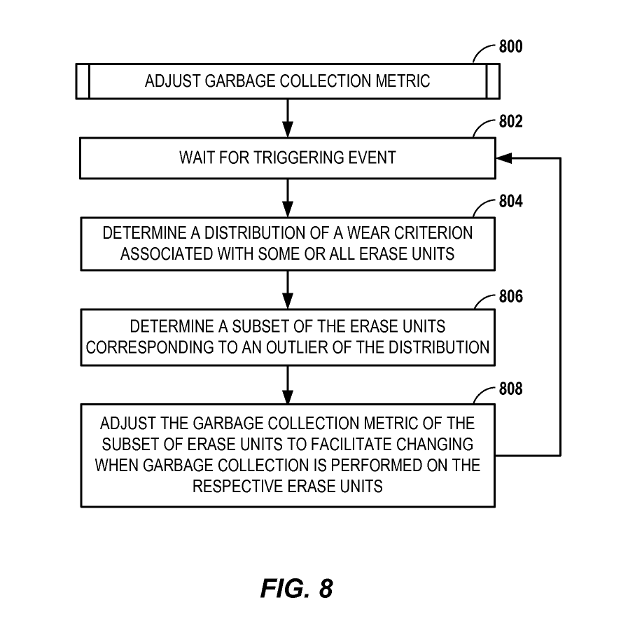

In reference now to FIG. 8, a flowchart illustrates another procedure 800 according to an example embodiment of the invention. This procedure 800 may be implemented in any apparatus described herein and equivalents thereof, and may also be implemented as a computer-readable storage medium storing processor-executable instructions. The procedure 800 involves adjusting a stale page count of selected erase units, and may include a wait state 802 for some external triggering event, e.g., a periodic sweep.

A distribution of a wear criterion associated with some or all erase units of flash memory apparatus is determined 804. A subset of the erase units corresponding to an outlier of the distribution is also determined 806. A garbage collection metric (e.g., adjusted stale count) of the subset of erase units is adjusted 808 to facilitate changing when garbage collection is performed on the respective erase units. This adjustment 808 may include incrementing or decrementing of the garbage collection metric, and the amount of adjustment 808 may vary with how far the wear criteria is from a mean or median of the distribution.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
establishing at least two groupings for a plurality of erase units that each comprise a plurality of flash memory units that are available for writing subsequent to erasure, wherein the groupings are based at least on a recent write frequency of data targeted for writing to the groupings;
determining a wear criteria for each of the erase units; and
assigning the erase units to one of the respective groupings based on the wear criteria of the respective erase units and further based on a wear range assigned to each of the at least two groupings.

2. The method of claim 1, wherein the at least two groupings include a hot grouping based on a higher recent write frequency of the data and a cold grouping based on a lower recent write frequency.

3. The method of claim 2, wherein the erase units comprise a high wear group and a low wear group, each having erase units with high and low wear criteria, respectively, relative to each other, and wherein assigning the erase units comprises assigning the high wear group to the cold grouping and the low wear group to the hot grouping.

4. The method of claim 3, wherein the erase units comprise an intermediate wear group having wear criteria between that of the high wear group and the low wear group, the method further comprising:
establishing a medium grouping based on a third recent write frequency between the respective write frequencies of the cold and hot groupings; and
assigning the intermediate wear group to the medium grouping.

5. The method of claim 1, wherein each grouping comprises a queue of the erase units, the method further comprising ordering the assigned erase units within the respective queues based on the wear criteria.

6. The method of claim 1, wherein the plurality of erase units are available for writing subsequent to erasure via garbage collection.

7. The method of claim 6, wherein the garbage collection is applied to the erase units based on a garbage collection metric, the method further comprising adjusting the garbage collection metric based on an amount of wear associated with the memory units, wherein the adjusted garbage collection metric changes when garbage collection is performed on the respective erase units.

8. The method of claim 7, wherein the garbage collection metric comprises at least one of a stale page count and an elapsed since data was last written to the erase unit.

9. An apparatus, comprising:
a plurality of erase units each comprising a plurality of flash memory units that are available for writing subsequent to erasure;
a controller configured to write to the erase units, the controller configured with instructions that cause the apparatus to:
establish at least two groupings for the erase units, wherein the groupings are based at least on a recent write frequency of data targeted for writing to the groupings;
determine a wear criteria for each of the erase units; and
assign the erase units to one of the respective groupings based on the wear criteria of the respective erase units and further based on a wear range assigned to each of the at least two groupings.

10. The apparatus of claim 9, wherein the at least two groupings include a hot grouping based on a higher recent write frequency of the data and a cold grouping based on a lower recent write frequency.

11. The apparatus of claim 10, wherein the erase units comprise a high wear group and a low wear group each having erase units with high and low wear criteria, respectively, relative to each other, and wherein assigning the erase units comprises assigning the high wear group to the cold grouping and the low wear group to the hot grouping.

12. The apparatus of claim 11, wherein the erase units comprise an intermediate wear group having wear criteria between that of the high wear group and the low wear group, wherein the instructions further cause the apparatus to:
establish a medium grouping based on a third recent write frequency between the respective write frequencies of the cold and hot groupings; and
assign the intermediate wear group to the medium grouping.

13. The apparatus of claim 9, wherein each grouping comprises a queue of the erase units, and wherein the instructions further cause the apparatus to order the assigned erase units within the respective queues based on the wear criteria.

14. The apparatus of claim 9, wherein the plurality of erase units are available for writing subsequent to erasure via garbage collection.

15. The apparatus of claim 9, wherein the garbage collection is applied to the erase units based on a garbage collection metric, and wherein the instructions further cause the apparatus to adjust the s garbage collection metric based on an amount of wear associated with the memory units to change when garbage collection is performed on the respective erase units.

16. The apparatus of claim 15, wherein the garbage collection metric comprises at least one of a stale page count and an elapsed since data was last written to the erase unit.

17. A method comprising:
determining a distribution of a wear criterion associated with each a plurality of erase units, wherein each erase unit comprises a plurality of flash memory units being considered for garbage collection based on a garbage collection metric associated with the respective erase unit;
determining a subset of the erase units corresponding to an outlier of the distribution; and
adjusting the garbage collection metric of the subset to facilitate changing when garbage collection is performed on the subset.

18. The method of claim 17, wherein a first part of the subset are more worn than those of the plurality of erase units not in the subset, and wherein the garbage collection metric of the first part is adjusted to reduce a time when garbage collection is performed on the first part; and wherein a second part of the subset are less worn than those of the plurality of erase units not in the subset, and wherein the garbage collection metric of the second part is adjusted to increase a time when garbage collection is performed on the second part.

19. The method of claim 17, further comprising adjusting the garbage collection metric differently for at least one erase units of the subset than for others of the subset based on the at least one erase unit being further outlying than the others of the subset.

20. The method of claim 17, wherein the garbage collection comprises at least one of a stale page count and an elapsed since data was last written to the erase unit.

21. An apparatus, comprising:
a plurality of erase units each comprising a plurality of flash memory units, being considered for garbage collection based on a garbage collection metric associated with the respective erase unit;
a controller configured to select the erase units for the garbage collection, the controller configured with instructions that cause the apparatus to:
determine a distribution of a wear criterion associated with each of the erase units;
determine a subset of the erase units corresponding to an outlier of the distribution; and
adjust the garbage collection metric of the subset of erase units to facilitate changing when garbage collection is performed on the subset of erase units.

22. The apparatus of claim 21, wherein a first part of the subset are more worn than those of the plurality of erase units not in the subset, and wherein the garbage collection metric of the first part is adjusted to reduce a time when garbage collection is performed on the first part; and wherein a second part of the subset are less worn than those of the plurality of erase units not in the subset, and wherein the garbage collection metric of the second part is adjusted to increase a time when garbage collection is performed on the second part.

23. The apparatus of claim 21, wherein the instructions further cause the apparatus to adjust the s garbage collection metric differently for at least one erase units of the subset than for others of the subset based on the at least one erase unit being further outlying than the others of the subset.

24. The apparatus of claim 21, wherein the garbage collection comprises at least one of a stale page count and an elapsed since data was last written to the erase unit.
